(19) United States
(12) Patent Application Publication
(10) Pub. No.: US 2024/0336864 A1
(43) Pub. Date: Oct. 10, 2024

(54) LIQUID CRYSTALLINE RESIN COMPOSITION AND BALL-BEARING SLIDING PART COMPRISING THE SAME

(71) Applicant: SAMSUNG ELECTRO-MECHANICS CO., LTD., Suwon-si (KR)

(72) Inventors: Namkeun OH, Suwon-si (KR); Jung Hyun PARK, Suwon-si (KR); Dohwan KIM, Suwon-si (KR); Sanghyun JI, Suwon-si (KR); Donghoon LEE, Suwon-si (KR); Dooseub SHIN, Suwon-si (KR); Ju Ho KIM, Suwon-si (KR)

(73) Assignee: SAMSUNG ELECTRO-MECHANICS CO., LTD., Suwon-si (KR)

(21) Appl. No.: 18/410,284

(22) Filed: Jan. 11, 2024

(30) Foreign Application Priority Data
Apr. 5, 2023 (KR) 10-2023-0044776
Jul. 20, 2023 (KR) 10-2023-0094724

(51) Int. Cl. C10M 169/04; C10M 107/28; C10M 109/00; C10M 111/06; C10M 125/02; C10M 125/22; C10M 125/26

(52) U.S. Cl. CPC C10M 169/04; C10M 107/28; C10M 109/00; C10M 111/06; C10M 125/02; C10M 125/22; C10M 125/26; C10M 2201/041; C10M 2201/084; C10M 2201/103; C10M 2201/105; C10M 2201/14; C10M 2209/0845; C10N 2020/06; C10N 2040/02

(57) ABSTRACT

A liquid crystalline resin composition including a liquid crystalline resin, an olefin-based copolymer, a micro filler having an average particle diameter (D50) of 3 μm or less, and a carbon-based filler, wherein a content of the micro filler is 6 to 20 wt % based on a total weight of the liquid crystalline resin composition, and an aspect ratio of the micro filler is 6 or less, and wherein a content of the olefin-based copolymer is 3 to 10 wt % based on the total weight of the liquid crystalline resin composition.

### CROSS-REFERENCE TO RELATED APPLICATIONS

This application claims the benefit under 35 USC 119 (a) of Korean Patent Application No. 10-2023-0044776 filed on Apr. 5, 2023, in the Korean Intellectual Property Office, and Korean Patent Application No. 10-2023-0094724 filed on Jul. 20, 2023, in the Korean Intellectual Property Office, the entire disclosures of which are incorporated herein by reference for all purposes.

### BACKGROUND

### 1. Field

The following description relates to a liquid crystalline resin composition and a ball-bearing sliding part comprising the same.

### 2. Description of the Background

Liquid crystalline resins represented by liquid crystalline polyester resins have a well-balanced combination of mechanical strength, heat resistance, chemical resistance, electrical properties, and the like, in addition to excellent dimensional stability, so they are widely used as highly functional engineering plastics.

In recent years, taking advantage of these characteristics, liquid crystalline resins are also used in precision instrument parts. Examples of parts for which liquid crystalline resins are used may include connectors, such as FPC connectors; sockets, such as memory card sockets; camera module parts, such as lens holders; and relays. These parts may be desired to have excellent surface whitening suppression, low warpage properties, weld strength, and low dust generation.

In addition, since there are cases in which two or more members are used in the form of being dynamically contacted, it is also required to reduce a sliding wear property (i.e., a wear-prone property when two or more members are in dynamic contact).

Among the above-described parts, in the case of a ball bearing sliding part that is used in such a form that a molded body made of a liquid crystalline resin composition and a ball bearing are in dynamic contact, it may be desired to reduce a ball bearing sliding wear property (i.e., a wear-prone property when in dynamic contact with the ball bearing).

In addition, if the ball bearing sliding part is easily scratched, broken, dented, and the like when subjected to an impact, there is a concern that a defect may occur in the dynamic contact between the ball bearing sliding part and the ball bearing.

Therefore, the ball bearing sliding part is also required to have improved impact resistance to drop deformation, i.e., characteristics that are less likely to cause scratches, breakages, dents, and the like, even when subjected to impact.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a liquid crystalline resin composition includes a liquid crystalline resin; an olefin-based copolymer; a micro filler having an average particle diameter (D50) of 3 μm or less; and a carbon-based filler, wherein a content of the micro filler is 6 to 20 wt % based on a total weight of the liquid crystalline resin composition, and an aspect ratio of the micro filler is 6 or less, and wherein a content of the olefin-based copolymer is 2 to 10 wt % based on the total weight of the liquid crystalline resin composition.

The micro filler may be silica, barium sulfate, talc, quartz powder, glass bead, glass powder, calcium silicate, aluminum silicate, potassium aluminum silicate, kaolin, clay, diatomaceous earth, wollastonite, iron oxide, titanium oxide, zinc oxide, alumina, calcium carbonate, magnesium carbonate, calcium sulfate, silicon carbide, silicon nitride, boron nitride, potassium titanate, calcium pyrophosphate, anhydrous dicalcium phosphate, or a combination thereof.

The liquid crystalline resin composition may further include a macro filler having an average particle diameter (D50) of greater than 3 μm, and in this case, a ratio of a content of the macro filler to the content of the micro filler may be 1 or less.

The ratio of the content of the macro filler to the content of the micro filler may be 0.5 or less.

The content of the macro filler may be 1.5 to 7 wt % based on the total weight of the liquid crystalline resin composition.

The average particle diameter (D50) of the macro filler may be 10 to 20 μm.

The micro filler may be silane-treated.

The content of the olefin-based copolymer may be 3 to 10 wt % based on the total weight of the liquid crystalline resin composition.

The olefin-based copolymer may be a copolymer comprising a first repeating unit derived from α-olefin and a second repeating unit derived from glycidyl ester of α,β-unsaturated acid.

The carbon-based filler may be carbon black.

A content of the carbon-based filler may be 2 to 5 wt % based on the total weight of the liquid crystalline resin composition.

The liquid crystalline resin composition may further include a wear filler, including molybdenum disulfide (MoS₂), molybdenum diselenide (MoSe₂), molybdenum sulfide selenide (MoSSe), molybdenum trioxide (MoO₃), tungsten disulfide (WS₂), tungsten selenide (WSe₂), tungsten sulfide selenide (WSSe), tungsten trioxide (WO₃) or a combination thereof, in a content of 0.5 wt % to 5 wt % based on the total weight of the liquid crystalline resin composition.

A ball-bearing sliding part may include the liquid crystalline resin composition described above.

In another one or more general aspect, a ball-bearing sliding part including a liquid crystalline resin composition, the liquid crystalline resin composition includes a liquid crystalline resin, an olefin-based copolymer, a micro filler having an average particle diameter (D50) of 3 μm or less, and a carbon-based filler. A content of the micro filler is 6 to 20 wt % based on a total weight of the liquid crystalline resin composition, and an aspect ratio of the micro filler is 6 or less, and wherein a content of the olefin-based copolymer is 3 to 10 wt % based on the total weight of the liquid crystalline resin composition.

Other features and aspects will be apparent from the following detailed description, the drawings, and the claims.

### BRIEF DESCRIPTION OF DRAWINGS

FIG. 1 correlates a drop/wear deformation value and a drive performance value (Stroke).

FIG. 2 correlates drop/wear deformation and drive performance values (Linearity).

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing. Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

Throughout the specification, ‘stacking direction’ refers to a direction in which components are sequentially stacked, may also be a ‘thickness direction’ perpendicular to the wide surface (main surface) of the sheet-like component, and corresponds to the T-axis direction in the drawings. In addition, ‘lateral direction’ refers to a direction extending parallel to the wide surface (main surface) from the edge of the sheet-like component, may be a ‘planar direction’, and corresponds to the L-axis direction in the drawings.

A liquid crystalline resin composition, according to an embodiment of the present description, includes a liquid crystalline resin, an olefin-based copolymer, a micro filler, and a carbon-based filler.

A liquid crystalline resin composition, according to an embodiment of the present description, includes a liquid crystalline resin.

Liquid crystalline resin refers to a melt-processable polymer that has a property capable of forming an optically anisotropic molten phase. Properties of the anisotropic molten phase can be confirmed by a conventional polarization test method using orthogonal polarizers. More specifically, the anisotropic molten phase can be confirmed by using a Leitz polarization microscope and observing a molten sample on a Leitz hot stage at a magnification ratio of 40 times under a nitrogen atmosphere. The liquid crystalline polymer, when tested between orthogonal polarizers, usually allows polarized light to pass therethrough even in a molten stationary state, and exhibits optical anisotropy.

The type of liquid crystalline resin is not particularly limited, and may be aromatic polyester and/or aromatic polyesteramide. In addition, polyester that partially includes aromatic polyester and/or aromatic polyesteramide in the same molecular chain may also be used. The liquid crystalline resin, when dissolved in pentafluorophenol at a concentration of 0.1% by mass at 60° C., may have a logarithmic viscosity (I.V.) of, for example, at least about 2.0 dl/g, or from 2.0 dl/g to 10.0 dl/g.

As an example, the liquid crystalline resin may be an aromatic polyester or aromatic polyesteramide with repeating units derived from aromatic hydroxycarboxylic acid, aromatic hydroxyamine, or aromatic diamine as a constituent component. Examples thereof may include polyester mainly including repeating units derived from aromatic hydroxycarboxylic acid or derivative thereof; polyester mainly including repeating units derived from aromatic hydroxycarboxylic acid or derivative thereof, and repeating units derived from aromatic dicarboxylic acid, alicyclic dicarboxylic acid, or derivatives thereof; polyester mainly including repeating units derived from aromatic hydroxycarboxylic acid or derivative thereof, repeating units derived from aromatic dicarboxylic acid, alicyclic dicarboxylic acid, or derivatives thereof, and repeating units derived from aromatic diol, alicyclic diol, aliphatic diol, or derivatives thereof; polyesteramide mainly including repeating units derived from aromatic hydroxycarboxylic acid or derivative thereof, repeating units derived from aromatic hydroxyamine, aromatic diamine, or derivatives thereof, and repeating units derived from aromatic dicarboxylic acid, alicyclic dicarboxylic acid, or derivatives thereof; polyesteramide mainly including repeating units derived from aromatic hydroxycarboxylic acid or derivative thereof, repeating units derived from aromatic hydroxyamine, aromatic diamine, or derivatives thereof, repeating units derived from aromatic dicarboxylic acid, alicyclic dicarboxylic acid, or derivatives thereof, and repeating units derived from aromatic diol, alicyclic diol, aliphatic diol, or derivatives thereof, and the like.

In addition, a specific compound constituting the liquid crystalline resin may include, for example, aromatic hydroxycarboxylic acid such as p-hydroxybenzoic acid or 6-hydroxy-2-naphthoic acid, aromatic diol such as 2,6-dihydroxynaphthalene, 1,4-dihydroxynaphthalene, 4,4′-dihydroxybiphenyl, hydroquinone, or resorcin, aromatic dicarboxylic acid such as terephthalic acid, isophthalic acid, 4,4′-diphenyldicarboxylic acid, or 2,6-naphthalene dicarboxylic acid, and aromatic amines such as p-aminophenol or p-phenylenediamine.

The liquid crystalline resin can be manufactured by a known method using direct polymerization or transesterification from monomers, and can usually be manufactured by methods such as melt polymerization, solution polymerization, slurry polymerization, or solid phase polymerization.

A compound capable of esterification may be used for polymerization or modified into a derivative capable of esterification from a precursor in a step before polymerization. A catalyst may be used during polymerization. The catalyst may be, for example, a metal salt-based catalyst such as potassium acetate, magnesium acetate, stannous acetate, tetrabutyl titanate, lead acetate, sodium acetate, antimony trioxide, and tris (2,4-pentanedionate) cobalt (III), or an organic compound-based catalyst such as N-methylimidazole and 4-dimethylaminopyridine. A used amount of catalyst may be 0.001 wt % to 1 wt %, or 0.01 wt % to 0.2 wt % based on the total weight of monomers. A molecular weight of the polymer manufactured by polymerization can be increased by solid phase polymerization in which heating is performed under reduced pressure or in an inert gas, if desired.

The content of the liquid crystalline resin may be 65 to 88 wt %, and more specifically, 70 to 85 wt % or 75 to 85 wt % based on the total weight of the liquid crystalline resin composition. If the content of the liquid crystalline resin is too small, the appearance may be poor, and the sliding wear property may deteriorate. If the content of the liquid crystalline resin is too large, dust generation may increase, and dimensional stability may deteriorate.

According to an embodiment of the present description, the liquid crystalline resin composition includes a micro filler.

The micro filler has an average particle diameter (D50) of 3 μm or less. As such, according to an embodiment of the present description, the liquid crystalline resin composition may have excellent resistance to drop deformation and wear deformation by including the micro filler with a sufficiently small average particle diameter. In the present specification, the average particle diameter (D50) may be defined as a particle diameter corresponding to 50% of the cumulative volume in the particle diameter distribution curve of particles. The average particle diameter (D50) may be measured using, for example, a laser diffraction method.

In addition, the content of the micro filler may be 6 to 20 wt %, and more specifically, 6 to 18 wt % based on the total weight of the liquid crystalline resin composition. If the content of the micro filler is too small, the mechanical strength is significantly reduced, and thus, the resistance to drop deformation and wear deformation of the liquid crystalline resin composition may deteriorate. If the content of the micro filler is too large, the mechanical strength excessively increases, and thus, resistance to drop deformation and wear deformation of the liquid crystalline resin composition may deteriorate.

In addition, an aspect ratio of the micro filler may be 6 or less, and more specifically, 5 or less. When the aspect ratio of the micro filler satisfies the above range, proper mechanical strength is ensured so that resistance to drop deformation and wear deformation of the liquid crystalline resin composition can be more preferably realized. In the present specification, the term “aspect ratio” of a particle means a ratio of the length of the longest side to the length of the shortest side in a particle.

The micro filler may be, for example, silica, barium sulfate, talc, quartz powder, glass bead, glass powder, calcium silicate, aluminum silicate, potassium aluminum silicate, kaolin, clay, diatomaceous earth, wollastonite, iron oxide, titanium oxide, zinc oxide, alumina, calcium carbonate, magnesium carbonate, calcium sulfate, silicon carbide, silicon nitride, boron nitride, potassium titanate, calcium pyrophosphate, anhydrous dicalcium phosphate, or combinations thereof, but is not necessarily limited thereto.

Meanwhile, the micro filler may be silane-treated. When the micro filler is silane-treated, the mechanical strength increases so that resistance to drop deformation and wear deformation of the liquid crystalline resin composition can be more preferably realized.

More specifically, the silane treatment may be performed by adding and mixing the micro filler and a silane treatment agent in an alcohol solvent, and then performing heat treatment at a temperature of about 25 to 60° C. for 60 to 240 minutes. The silane treatment agent may be amino silane as a hydrophilic silane treatment agent or acryl silane, phenyl silane or a combination thereof as a hydrophobic silane treatment agent. When the hydrophilic silane treatment agent is used, hydrogen bonds are formed to increase mechanical strength. When the hydrophobic silane treatment agent is used, pi-pi bonds can increase mechanical strength. The alcohol solvent may be, for example, IPA, methanol, ethanol, or a combination thereof.

Optionally, the liquid crystalline resin composition, according to an embodiment of the present description, may include a macro filler with an average particle diameter (D50) greater than 3 μm.

In this case, the ratio of the content of the macro filler to the content of the micro filler may be 1 or less, and more specifically, 0.5 or less. When the ratio of the content of the macro filler to the content of the micro filler satisfies the above range, the mechanical strength is increased so that resistance to drop deformation and wear deformation of the liquid crystalline resin composition can be more preferably realized. More specifically, the content of the macro filler may be 1.5 to 7 wt % based on the total weight of the liquid crystalline resin composition.

The average particle diameter (D50) of the macro filler may be 10 to 20 μm, and more specifically, 13 to 18 μm. If the average particle diameter of the macro filler is too small, the mechanical strength is significantly reduced, and thus, the resistance to drop deformation and wear deformation of the liquid crystalline resin composition may deteriorate. If the average particle diameter of the macroscopic filler is too large, the mechanical strength excessively increases, and thus, the resistance to drop deformation and wear deformation of the liquid crystalline resin composition may deteriorate.

For example, the macro filler may be mica, glass flake, metal flake, or a combination thereof, but is not necessarily limited thereto.

According to an embodiment of the present description, the liquid crystalline resin composition includes an olefin-based copolymer.

The olefin-based copolymer may improve impact resistance to external impact of the liquid crystalline resin composition. The olefin-based copolymer may include repeating units derived from α-olefin and repeating units derived from glycidyl ester of α,β-unsaturated acid. α-olefin may be ethylene, propylene, butene, or the like, and glycidyl ester of α,β-unsaturated acid may be acrylic acid glycidyl ester, methacrylic acid glycidyl ester, or ethacrylic acid glycidyl ester.

The content of the olefin-based copolymer may be 3 to 10 wt %, more specifically 5 to 10 wt %, based on the total weight of the liquid crystalline resin composition. If the content of the olefin-based copolymer is too small, the mechanical strength excessively increases, and thus, the resistance to drop deformation and wear deformation of the liquid crystalline resin composition may deteriorate. If the content of the olefin-based copolymer is too large, the mechanical strength is significantly reduced, and thus, the resistance to drop deformation and wear deformation of the liquid crystalline resin composition may deteriorate, and other physical properties and appearance may become poor.

The liquid crystalline resin composition, according to an embodiment of the present description, includes a carbon-based filler.

More specifically, the carbon-based filler may be carbon black. The coloring is not limited to carbon black as long as it is generally available in resin coloring. Carbon black generally contains secondary particles formed by aggregation of primary particles. However, unless a significant amount of secondary particles with a size of 50 μm or greater is included, many fine protrusions are not generated on the surface of a molded body manufactured by molding a liquid crystalline resin composition. For example, a content rate of secondary particles having a particle diameter of 50 μm or greater may be 20 ppm or less, or 5 ppm or less.

The content of the carbon-based filler may be 2 to 5 wt %, and more specifically, 2 to 4 wt % based on the total weight of the liquid crystalline resin composition. If the content of the carbon-based filler is too small, the coloring of the liquid crystalline resin composition may deteriorate, and the resistance to drop deformation and wear deformation of the liquid crystalline resin composition may deteriorate. If the content of the carbon-based filler is too large, the cost increases, fine protrusions may be generated on the surface of the molded body, and the resistance to drop deformation and wear deformation of the liquid crystalline resin composition may deteriorate.

Optionally, the liquid crystalline resin composition, according to an embodiment of the present description, may include a wear filler.

The wear filler may be a sulfide, selenide, or oxide of chromium (Cr), molybdenum (Mo), or tungsten (W). For example, the wear filler may be molybdenum disulfide (MoS₂), molybdenum diselenide (MoSe₂), molybdenum sulfide selenide (MoSSe), molybdenum trioxide (MoO₃), tungsten disulfide (WS₂), tungsten selenide (WSe₂), tungsten sulfide selenide (WSSe), tungsten trioxide (WO₃) or a combination thereof, but is not limited thereto.

The wear filler has a layered structure in which, for example, layers of metal such as chromium (Cr), molybdenum (Mo), or tungsten (W) sandwiched between two layers of sulfur are stacked, has characteristics that the layers are likely to slide due to weak van der Waals' force acting between the layers and a friction coefficient is low, and acts as a lubricant.

The liquid crystalline resin composition may include 0.5 wt % to 5 wt %, or 1 wt % to 3 wt % of the wear filler based on the total weight of the liquid crystalline resin composition. If the content of the wear filler is less than 0.5 wt %, dust generation may increase and sliding wear may decrease. If the content exceeds 5 wt %, the appearance may become poor, and physical properties may deteriorate.

Optionally, to the liquid crystalline resin composition, other fillers, and other components such as known additives generally added to synthetic resins, i.e., stabilizers such as antioxidants and ultraviolet absorbers, antistatic agents, flame retardants, colorants such as dyes and pigments, lubricants, release agents, crystallization accelerators, and crystal nucleating agents may also be appropriately added according to required performance to the extent that the desired effect is not impaired. Examples of the other fillers may include a granular filler such as gypsum (potassium sulfate dihydrate), a platy filler such as talc, or a fibrous filler such as whisker.

A method for manufacturing the liquid crystalline resin composition is not particularly limited. For example, the liquid crystalline resin composition may be manufactured by blending the liquid crystalline resin and the fillers and subjecting the resultant mixture to melt-kneading using a single screw extruder or a twin screw extruder.

The liquid crystalline resin composition may have a melt viscosity of 90 Pa·sec or less, or 80 Pa·sec or less, from standpoints of fluidity and moldability during melting. The melt viscosity can be obtained by a measurement method in conformity with ISO 11443 under conditions of a cylinder temperature 10° C. to 20° C. higher than the melting point of the liquid crystalline resin and a shear rate of 1000 sec⁻¹.

According to another embodiment of the present description, a ball-bearing sliding part is manufactured using the liquid crystalline resin composition described above.

The ball bearing sliding part is excellent in resistance to drop deformation and wear deformation, and at the same time, has surface whitening suppression, low warpage, excellent welding strength, and low dust generation.

The ball-bearing sliding part can be used for a part in dynamic contact with a ball bearing and, for example, for a lens holder of a camera module.

The following Examples illustrate the present embodiments in more detail.

### Examples: Manufacture of Liquid Crystalline Resin Compositions

Liquid crystalline resin compositions were formed by blending liquid crystalline resin (SEYANG® LCP G600BB resin), olefin-based copolymer, carbon black, mica (average particle diameter (D50): 15 μm), silica (average particle diameter (D50): 5 μm, 2 μm, 0.5 μm), BaSO₄ (average particle diameter (D50): 0.7 μm), and talc (average particle diameter (D50): 1 μm, 2 μm) with the contents shown in Table 1 below, and melting and kneading the resultant mixture in a twin screw extruder (L/D: 44, diameter: 30 mm). During melt-kneading, the extruder barrel temperature was 340° C., and by-products were removed under vacuum conditions.

Thereafter, the liquid crystalline resin composition formed through melting and kneading was mixed for 30 minutes in a mixer, and then dried at 150° C. for 2 hours in a hot air dryer.

In Example 9, BaSO₄ was sufficiently dispersed at 500 RPM at 25° C. for 4 hours in an IPA solvent, and after confirming uniform mixing while adding a phenyl silane treatment agent at 35° C., the mixture was stirred for 1 hour. Thereafter, silane treatment was performed by, after primary drying at 60° C. for 2 hours in an oven and then secondary drying at 135° C. for 4 hours for removal of the solvent and silane treatment agent residues, performing finally vacuum drying at 0.1 Bar for 12 hours in a vacuum oven.

### Comparative Examples: Manufacture of Liquid Crystalline Resin Compositions

Liquid crystalline resin compositions were manufactured in the same manner as in Example 1, except that the blending components and contents were changed, as shown in Table 1 below.

### Experimental Examples: Measurement of Drop/Wear Deformation Values of Liquid Crystalline Resin Compositions

The drop/wear deformation values of the liquid crystalline resin compositions manufactured in the Examples and the Comparative Examples were measured using a 3D microscope, and the results are summarized in Tables 1 and 2.

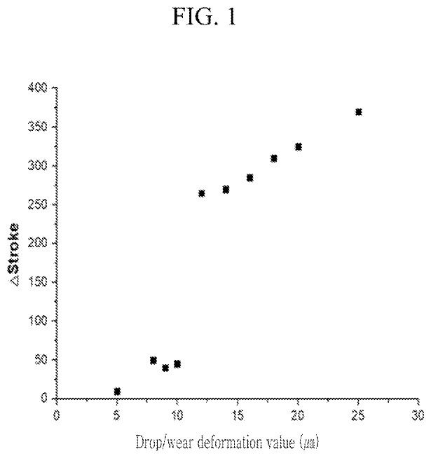

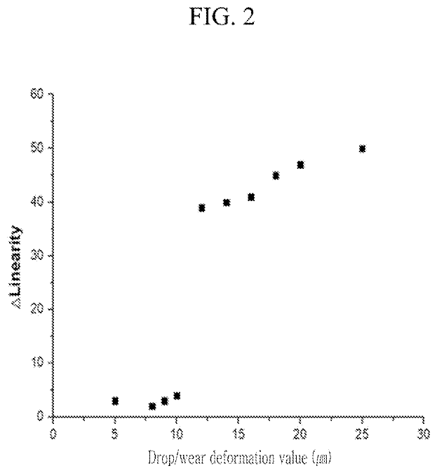

In addition, the correlativity between the drop/wear deformation value and the drive performance value (Stroke, Linearity) were measured, and the results are shown in FIGS. 1 and 2.

The drop test and drive performance evaluation were conducted to measure the correlativity between the drop/wear deformation value and the drive performance value (Stroke, Linearity).

Before introducing the drop experiment, measuring the initial drive performance value of the ball-bearing sliding part may be desired. The drive performance value is measured through a full sweep drive of the ball-bearing sliding part, and actual drive data is acquired with a position sensor while sweeping the entire drive range. Stroke is a calculated value of the maximum drive distance, and linearity is the calculated value of linearity of the drive characteristics. After measuring the initial drive performance, the ball-bearing sliding part is put into the dropping equipment, and the dropping test is repeatedly conducted. At this time, the drive performance value is measured by measuring again the initial drive performance value after dropping. Then, the ball bearing sliding part is disassembled, and the maximum drop/wear deformation value of the sliding portion is measured using the measurement equipment (3D microscope, etc.).

TABLE 1

| | Average | | Compar- | Compar- | Compar- | | | | | | | |
|---|---|---|---|---|---|---|---|---|---|---|---|---|
| | particle | | ative | ative | ative | | | | | | | |
| | diameter | Aspect | exam- | exam- | exam- | Exam- | Exam- | Exam- | Exam- | Exam- | Exam- | Exam- |
| Composition | (D50, μm) | ratio | ple 1 | ple 2 | ple 3 | ple 1 | ple 2 | ple 3 | ple 4 | ple 5 | ple 6 | ple 7 |
| liquid | — | — | 79 | 85 | 79 | 79 | 83 | 79 | 79 | 81 | 79 | 79 |
| crystalline | | | | | | | | | | | | |
| resin | | | | | | | | | | | | |
| (wt %) | | | | | | | | | | | | |
| olefin-based | — | — | 7 | 7 | 7 | 7 | 7 | 7 | 7 | 7 | 7 | 7 |
| copolymer | | | | | | | | | | | | |
| (wt %) | | | | | | | | | | | | |
| mica | 15 | 20 | 11 | | 6 | 5 | | 4 | 3 | | 2 | |
| (wt %) | | | | | | | | | | | | |
| silica | 5 | 1 | | | | | | | | | | |
| (wt %) | 2 | 1 | | | | | | | | | | |
| (granular) | 0.5 | 1 | | 5 | 5 | 6 | 7 | 7 | 8 | 9 | 9 | 11 |
| silane treated | 0.7 | 1 | | | | | | | | | | |
| BaSO₄ | | | | | | | | | | | | |
| (wt %) | | | | | | | | | | | | |
| BaSO₄ (wt %) | 0.7 | 1 | | | | | | | | | | |
| talc | 1 | 5 | | | | | | | | | | |
| (wt %) | 2 | 10 | | | | | | | | | | |
| carbon black | — | — | 3 | 3 | 3 | 3 | 3 | 3 | 3 | 3 | 3 | 3 |
| (wt %) | | | | | | | | | | | | |
| sum | — | — | 100 | 100 | 100 | 100 | 100 | 100 | 100 | 100 | 100 | 100 |
| (wt %) | | | | | | | | | | | | |
| drop/wear | — | — | 20 | 13 | 13 | 8 | 9 | 7 | 6 | 6 | 5 | 3 |
| deformation | | | | | | | | | | | | |
| value | | | | | | | | | | | | |
| (μm) | | | | | | | | | | | | |

TABLE 2

| | Average | | | | | | | | Compar- | Compar- | Compar- | Compar- |
|---|---|---|---|---|---|---|---|---|---|---|---|---|
| | particle | | | | | | | | ative | ative | ative | ative |
| | diameter | Aspect | Exam- | Exam- | Exam- | Exam- | Exam- | Exam- | exam- | exam- | exam- | exam- |
| Composition | (D50, μm) | ratio | ple 8 | ple 9 | ple 10 | ple 11 | ple 12 | ple 13 | ple 4 | ple 5 | ple 6 | ple 7 |
| liquid | — | — | 79 | 79 | 79 | 79 | 77 | 75 | 75 | 79 | 73 | 84 |
| crystalline | | | | | | | | | | | | |
| resin | | | | | | | | | | | | |
| (wt %) | | | | | | | | | | | | |
| olefin-based | — | — | 7 | 7 | 7 | 7 | 7 | 7 | 7 | 7 | 7 | 2 |
| copolymer | | | | | | | | | | | | |
| (wt %) | | | | | | | | | | | | |
| mica | 15 | 20 | | | | | | | | | | |
| (wt %) | | | | | | | | | | | | |
| silica | 5 | 1 | | | | | | | | 11 | | |
| (wt %) | 2 | 1 | | | 11 | | | | | | | |
| (granular) | 0.5 | 1 | | | | | 16 | 20 | | | 25 | 11 |
| silane treated | 0.7 | 1 | 11 | | | | | | | | | |
| BaSO₄ | | | | | | | | | | | | |
| (wt %) | | | | | | | | | | | | |
| BaSO₄ (wt %) | 0.7 | 1 | | 11 | | | | | | | | |
| talc | 1 | 5 | | | | 11 | | | | | | |
| (wt %) | 2 | 10 | | | | | | | 11 | | | |
| carbon black | — | — | 3 | 3 | 3 | 3 | 3 | 3 | 3 | 3 | 3 | 3 |
| (wt %) | | | | | | | | | | | | |
| sum | — | — | 100 | 100 | 100 | 100 | 100 | 100 | 100 | 100 | 100 | 100 |
| (wt %) | | | | | | | | | | | | |
| drop/wear | — | — | 4 | 7 | 8 | 9 | 6 | 10 | 13 | 13 | 13 | 14 |
| deformation | | | | | | | | | | | | |
| value | | | | | | | | | | | | |
| (μm) | | | | | | | | | | | | |

Referring to FIGS. 1 and 2, it can be confirmed that the drive performance values are significantly increased when the drop/wear deformation value of the liquid crystalline resin composition is 10 μm or less. In addition, it can be seen that the Examples will have excellent drive performance values because the drop/wear deformation value is 10 μm or less.

More specifically, referring to Tables 1 and 2, in the case of Examples 1 to 12 in which the content and aspect ratio of the micro filler are appropriately adjusted within the range according to the present description, or the macro filler is further included, but the content of the macro filler is appropriately adjusted within the range according to the present description, it could be confirmed that the drop/wear deformation value was 10 μm or less, indicating an excellent value.

In particular, in the case of Example 8, in which the micro filler was silane-treated, it could be confirmed that the drop/wear deformation value was significantly reduced, as compared with Example 9, in which the same micro filler was used but not silane-treated.

In the case of Comparative Example 1, it could be confirmed that the liquid crystalline resin composition included only the macro filler without including the micro filler; as a result, the drop/wear deformation value significantly deteriorated.

In the case of Comparative Example 2, it could be confirmed that the content of the micro filler was too small (5 wt %); as a result, the drop/wear deformation value deteriorated.

In the case of Comparative Example 3, it could be confirmed that, although the liquid crystalline resin composition included the micro filler and the macro filler, the ratio of the content of the macro filler to the content of the micro filler was greater than 1; as a result, the drop/wear deformation value deteriorated.

In the case of Comparative Example 4, it could be confirmed that, although the liquid crystalline resin composition included the micro filler in an appropriate amount, the aspect ratio of the micro filler was too large; as a result, the drop/wear deformation value deteriorated. In the case of Comparative Example 5, it could be confirmed that the average particle diameter (D50) of the micro filler was too large (5 μm), which is greater than 3 μm; as a result, the drop/wear deformation value deteriorated.

In the case of Comparative Example 6, it could be confirmed that the content of the micro filler was too large (25 wt %); as a result, the drop/wear deformation value deteriorated.

In the case of Comparative Example 7, it could be confirmed that, although the liquid crystalline resin composition included the micro filler in an appropriate amount, the content of the olefin-based copolymer was too small (2 wt %); as a result, the drop/wear deformation value deteriorated.

The present disclosure discloses, but not limited to, a liquid crystalline resin composition that is excellent in resistance to drop deformation and wear deformation and capable of preventing deterioration in drive performance due to drop deformation and wear deformation of a ball-bearing sliding part.

The liquid crystalline resin composition according to an embodiment of the present description is excellent in resistance to drop deformation and wear deformation, and can prevent deterioration in drive performance due to drop deformation and wear deformation of a ball bearing sliding part.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A liquid crystalline resin composition comprising:
a liquid crystalline resin;
an olefin-based copolymer;
a micro filler having an average particle diameter (D50) of 3 μm or less; and
a carbon-based filler,
wherein a content of the micro filler is 6 to 20 wt % based on a total weight of the liquid crystalline resin composition, and an aspect ratio of the micro filler is 6 or less, and
wherein a content of the olefin-based copolymer is 3 to 10 wt % based on the total weight of the liquid crystalline resin composition.

2. The liquid crystalline resin composition of claim 1,
wherein the micro filler is silica, barium sulfate, talc, quartz powder, glass bead, glass powder, calcium silicate, aluminum silicate, potassium aluminum silicate, kaolin, clay, diatomaceous earth, wollastonite, iron oxide, titanium oxide, zinc oxide, alumina, calcium carbonate, magnesium carbonate, calcium sulfate, silicon carbide, silicon nitride, boron nitride, potassium titanate, calcium pyrophosphate, anhydrous dicalcium phosphate, or a combination thereof.

3. The liquid crystalline resin composition of claim 1,
further comprising a macro filler having an average particle diameter (D50) of greater than 3 μm,
wherein a ratio of a content of the macro filler to the content of the micro filler is 1 or less.

4. The liquid crystalline resin composition of claim 3,
wherein the ratio of the content of the macro filler to the content of the micro filler is 0.5 or less.

5. The liquid crystalline resin composition of claim 3,
wherein the content of the macro filler is 1.5 to 7 wt % based on the total weight of the liquid crystalline resin composition.

6. The liquid crystalline resin composition of claim 3,
wherein the average particle diameter (D50) of the macro filler is 10 to 20 μm.

7. The liquid crystalline resin composition of claim 1,
wherein the micro filler is silane-treated.

8. The liquid crystalline resin composition of claim 1,
wherein the content of the olefin-based copolymer is 5 to 10 wt % based on the total weight of the liquid crystalline resin composition.

9. The liquid crystalline resin composition of claim 1,
wherein the olefin-based copolymer is a copolymer comprising a first repeating unit derived from α-olefin and a second repeating unit derived from glycidyl ester of α,β-unsaturated acid.

10. The liquid crystalline resin composition of claim 1,
wherein the carbon-based filler is carbon black.

11. The liquid crystalline resin composition of claim 1,
wherein a content of the carbon-based filler is 2 to 5 wt % based on the total weight of the liquid crystalline resin composition.

12. The liquid crystalline resin composition of claim 1,
further comprising a wear filler, comprising molybdenum disulfide (MoS₂), molybdenum diselenide (MoSe₂), molybdenum sulfide selenide (MoSSe), molybdenum trioxide (MoO₃), tungsten disulfide (WS₂), tungsten selenide (WSe₂), tungsten sulfide selenide (WSSe), tungsten trioxide (WO₃) or a combination thereof, in a content of 0.5 wt % to 5 wt % based on the total weight of the liquid crystalline resin composition.

13. A ball-bearing sliding part comprising a liquid crystalline resin composition, the liquid crystalline resin composition comprising:
a liquid crystalline resin;
an olefin-based copolymer;
a micro filler having an average particle diameter (D50) of 3 μm or less; and
a carbon-based filler,
wherein a content of the micro filler is 6 to 20 wt % based on a total weight of the liquid crystalline resin composition, and an aspect ratio of the micro filler is 6 or less, and
wherein a content of the olefin-based copolymer is 3 to 10 wt % based on the total weight of the liquid crystalline resin composition.

14. The ball-bearing sliding part of claim 13,
wherein the micro filler is silica, barium sulfate, talc, quartz powder, glass bead, glass powder, calcium silicate, aluminum silicate, potassium aluminum silicate, kaolin, clay, diatomaceous earth, wollastonite, iron oxide, titanium oxide, zinc oxide, alumina, calcium carbonate, magnesium carbonate, calcium sulfate, silicon carbide, silicon nitride, boron nitride, potassium titanate, calcium pyrophosphate, anhydrous dicalcium phosphate, or a combination thereof.

15. The ball-bearing sliding part of claim 13,
wherein the liquid crystalline resin composition further comprises a macro filler having an average particle diameter (D50) of greater than 3 μm,
wherein a ratio of a content of the macro filler to the content of the micro filler is 1 or less.

16. The ball-bearing sliding part of claim 15,
wherein the ratio of the content of the macro filler to the content of the micro filler is 0.5 or less.

17. The ball-bearing sliding part of claim 15,
wherein the content of the macro filler is 1.5 to 7 wt % based on the total weight of the liquid crystalline resin composition.

18. The ball-bearing sliding part of claim 15,
wherein the average particle diameter (D50) of the macro filler is 10 to 20 μm.

19. The ball-bearing sliding part of claim 13,
wherein the micro filler is silane-treated.

20. The ball-bearing sliding part of claim 13,
wherein the content of the olefin-based copolymer is 5 to 10 wt % based on the total weight of the liquid crystalline resin composition.
